(19) United States
(12) Patent Application Publication
(10) Pub. No.: US 2020/0148043 A1
(43) Pub. Date: May 14, 2020

(54) SLIDE DOOR SUPPORT DEVICE

(71) Applicant: AISIN SEIKI KABUSHIKI KAISHA, Kariya-shi (JP)

(72) Inventors: Tomohito Kiryu, Kariya-shi (JP); Taiki Ishiguro, Kariya-shi (JP)

(73) Assignee: AISIN SEIKI KABUSHIKI KAISHA, Kariya-shi (JP)

(21) Appl. No.: 16/675,334

(22) Filed: Nov. 6, 2019

(30) Foreign Application Priority Data
Nov. 13, 2018 (JP) 2018-212906

(51) Int. Cl. B60J 5/06; E05D 15/10; E05D 15/06

(52) U.S. Cl. CPC B60J 5/06; E05D 15/1081; E05D 2015/1092; E05Y 2900/531; E05D 15/0621

(57) ABSTRACT

A slide door support device supports a slide door that opens and closes a door opening formed on a side surface of a vehicle body. The slide door support device includes first and second lower rails and a lower guide unit. The lower guide unit includes a first lower guide roller moving along the first lower rail, a second lower guide roller moving along the second lower rail, a lower fixed portion fixed to the slide door, a lower rotational arm rotatable relative to the lower fixed portion and supporting the first and second lower guide rollers, and a pressing member pressing the lower fixed portion. An arm angle made by the lower fixed portion and the lower rotational arm gradually decreases as an opened degree of the slide door decreases. The pressing member presses the lower fixed portion in a direction of increasing the arm angle.

### CROSS REFERENCE TO RELATED APPLICATIONS

This application is based on and claims priority under 35 U.S.C. § 119 to Japanese Patent Application No. 2018-212906, filed on Nov. 13, 2018, the entire content of which is incorporated herein by reference.

### TECHNICAL FIELD

This disclosure generally relates to a slide door support device.

### BACKGROUND DISCUSSION

Conventionally, there is known a vehicle including a vehicle body that includes a side surface on which a door opening is formed, a slide door that opens and closes the door opening, and a slide door support device that supports the slide door at the vehicle body. The slide door support device supports the slide door so as to be movable in a vehicle front-rear direction in such a way that the slide door can open and close the door opening. The slide door support device supports the slide door so as to be movable in a vehicle width direction in such a way that the slide door does not interfere with the vehicle body when moving in the vehicle front-rear direction.

For example, as illustrated in FIG. 10, the Reference (JP 2018-80468A) describes a slide door support device 100 including a first lower rail 110 and a second lower rail 120 being arranged at a lower end portion of a door opening, and a lower guide unit 130 connected to a lower end portion of a slide door 200.

The first lower rail 110 includes a straight portion 111 extending in a vehicle front-rear direction, and a curved portion 112 curved so as to extend inward in a vehicle width direction as a position shifts to a vehicle front. The second lower rail 120 includes a straight portion 121 extending in the vehicle front-rear direction, and a curved portion 122 curved in such a way that a distance from the first lower rail 110 gradually decreases as a position shifts to the vehicle front. Meanwhile, the lower guide unit 130 includes a first lower guide roller 131 moving along the first lower rail 110, and a second lower guide roller 132 moving along the second lower rail 120. Further, the lower guide unit 130 includes a rotational arm 134 whose distal end portion supports the first lower guide roller 131 and the second lower guide roller 132 and whose proximal end portion is rotatably connected to the slide door 200.

The first lower guide roller 131 moves along the straight portion 111 of the first lower rail 110, and the second lower guide roller 132 moves along the straight portion 121 of the second lower rail 120, and thereby, the rotational arm 134 supporting the first lower guide roller 131 and the second lower guide roller 132 moves in the vehicle front-rear direction. As a result, the slide door 200 connected to the rotational arm 134 moves in the vehicle front-rear direction. Further, the first lower guide roller 131 moves along the straight portion 111 and the curved portion 112 of the first lower rail 110, and the second lower guide roller 132 moves along the curved portion 122 of the second lower rail 120, and thereby, the rotational arm 134 supporting the first lower guide roller 131 and the second lower guide roller 132 moves in the vehicle width direction while moving in the vehicle front-rear direction. As a result, the slide door 200 connected to the rotational arm 134 moves in the vehicle width direction while moving in the vehicle front-rear direction.

In the vehicle as described above, when an opened degree of the slide door 200 is small, moment of rotating the rotational arm 134 is generated due to a form of engagement of the first lower rail 110 and the second lower rail 120 with the lower guide unit 130. Specifically, the moment is generated, causing rotation of the rotational arm 134 in such a way that a proximal end portion of the rotational arm 134 moves to the vehicle front relative to a distal end portion of the rotational arm 134. For this reason, when an opened degree of the slide door 200 is small, the moment generated in the rotational arm 134 causes force of pushing, to the vehicle front (in a closing direction), the slide door 200 supported by the proximal end portion of the rotational arm 134. As a result, there is a possibility that, when a user of the vehicle operates the slide door 200 to be opened and closed, the user may have a sense of incongruity, or operability of the slide door 200 is degraded.

A need thus exists for a slide door support device which is not susceptible to the drawback mentioned above.

### SUMMARY

A slide door support device according to this disclosure supports, at a vehicle body, a slide door that opens and closes a door opening formed on a side surface of the vehicle body. The slide door support device includes first and second lower rails and a lower guide unit. The first lower rail is arranged at a lower end portion of the door opening. The second lower rail is arranged at the lower end portion of the door opening and on an inner side of the first lower rail in a vehicle width direction. The lower guide unit is connected to a lower end portion of the slide door. The first lower rail includes a straight portion extending to a vehicle front, and a curved portion curved so as to extend inward in the vehicle width direction as a position shifts from a front end of the straight portion to the vehicle front. The second lower rail includes a straight portion extending to the vehicle front, and a curved portion curved in such a way that a distance from the first lower rail gradually decreases as a position shifts from a front end of the straight portion to the vehicle front. The lower guide unit includes a first lower guide roller moving along the first lower rail, a second lower guide roller moving along the second lower rail, a lower fixed portion fixed to the slide door, a lower rotational arm including a proximal end portion connected so as to be rotatable relative to the lower fixed portion and supporting the first lower guide roller and the second lower guide roller at positions closer to a distal end than the proximal end portion, and a pressing member pressing the lower fixed portion. An angle made by the lower fixed portion and the lower rotational arm is assumed to be an arm angle. When the first lower guide roller moves along the straight portion and the curved portion of the first lower rail, and the second lower guide roller moves along the curved portion of the second lower rail, the arm angle gradually decreases as an opened degree of the slide door decreases. The pressing member presses the lower fixed portion in a direction of increasing the arm angle.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a side view of a vehicle including a slide door support device;

FIG. 2 is a plan view of an upper rail and an upper guide unit;

FIG. 3 is an exploded perspective view of the upper rail and the upper guide unit;

FIG. 4 is an end view of the upper rail and the upper guide unit;

FIG. 5 is a plan view of a lower rail and a lower guide unit;

FIG. 6 is an exploded perspective view of the lower rail and the lower guide unit;

FIG. 7 is an end view of the lower rail and the lower guide unit;

FIG. 8A and FIG. 8B are plan views for illustrating operation of the lower guide unit

FIG. 9A and FIG. 9B are plan views for illustrating operation of the lower guide unit; and

FIG. 10 is a plan view of a slide door support device in the prior art.

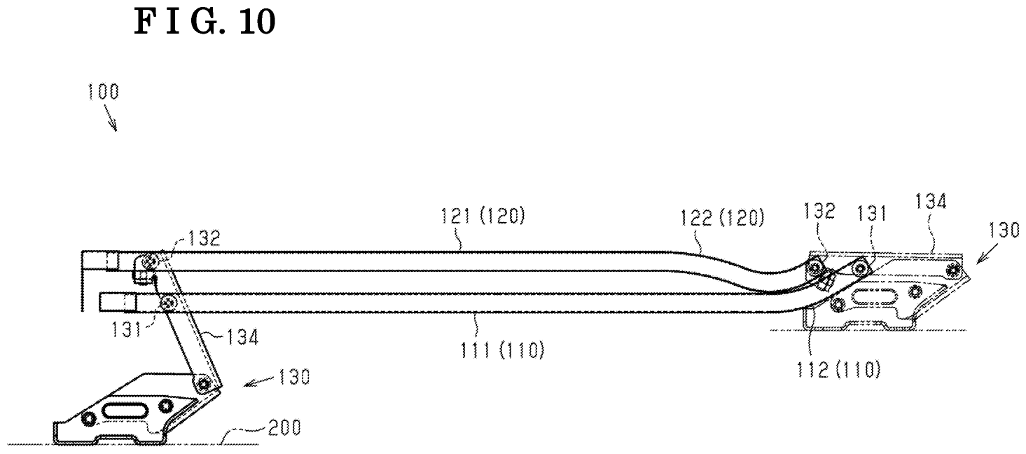

### DETAILED DESCRIPTION

Hereinafter, one embodiment of a vehicle including a slide door support device is described with reference to the drawings.

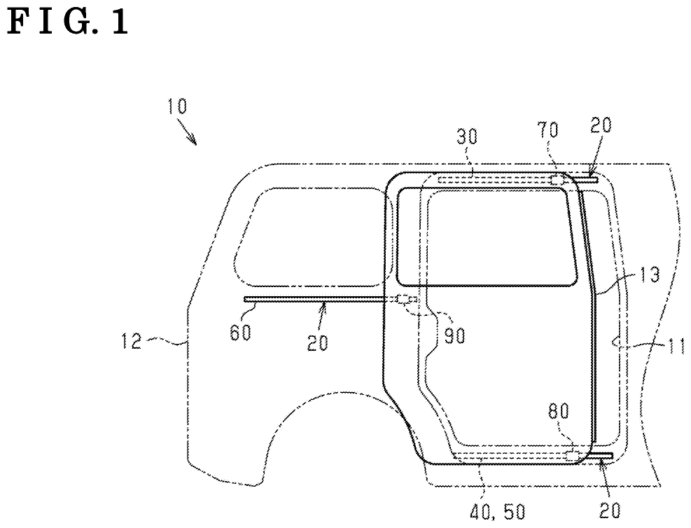

As illustrated in FIG. 1, the vehicle 10 includes a vehicle body 12 including a side surface on which a door opening 11 is provided, a slide door 13 opening and closing the door opening 11, and a slide door support device 20 supporting the slide door 13 at the vehicle body 12.

The slide door 13 is opened and closed between a fully closed position of preventing a passenger from getting on and off the vehicle 10 via the door opening 11 and a fully opened position of enabling a passenger to get on and off the vehicle 10 via the door opening 11. In the following description, an opened condition of the slide door 13 is referred to also as an opened degree of the slide door 13. Specifically, an opened degree of the slide door 13 becomes minimum at the fully closed position, and becomes maximum at the fully opened position. In this embodiment, it is assumed that the slide door 13 is a slide door manually operated by a user of the vehicle 10.

As illustrated in FIG. 1, the slide door support device 20 includes an upper rail 30 arranged at an upper end portion of the door opening 11, a first lower rail 40 and a second lower rail 50 arranged at a lower end portion of the door opening 11, and a central rail 60 arranged on a rear side of the door opening 11. The upper rail 30, the first lower rail 40, the second lower rail 50, and the central rail 60 are arranged in concave portions formed in the vehicle body 12, for example. The upper rail 30 is arranged on a vehicle upper side of the central rail 60, and the first lower rail 40 and the second lower rail 50 are arranged on a vehicle lower side of the central rail 60.

The slide door support device 20 includes an upper guide unit 70 connected to an upper end portion of the slide door 13, a lower guide unit 80 connected to a lower end portion of the slide door 13, and a central guide unit 90 connected to a center portion of the slide door 13 in a vehicle vertical direction. The upper guide unit 70 and the lower guide unit 80 are connected to positions near a front end of the slide door 13, and the central guide unit 90 is connected to a position near a rear end of the slide door 13.

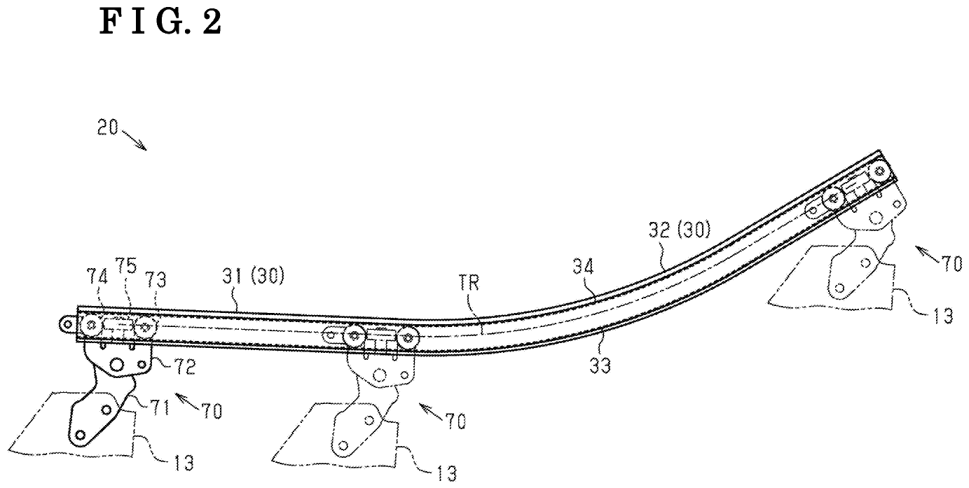

Next, the upper rail 30 and the upper guide unit 70 are described in detail with reference to FIGS. 2 to 4.

As illustrated in FIG. 2, the upper rail 30 includes a straight portion 31 extending to a vehicle front, and a curved portion 32 curved so as to extend inward in a vehicle width direction as a position shifts from a front end of the straight portion 31 to the vehicle front. In this embodiment, the straight portion 31 extending to the vehicle front includes not only a straight portion extending in parallel with a vehicle front-rear direction but also a straight portion extending in a direction slightly inclined from the vehicle front-rear direction.

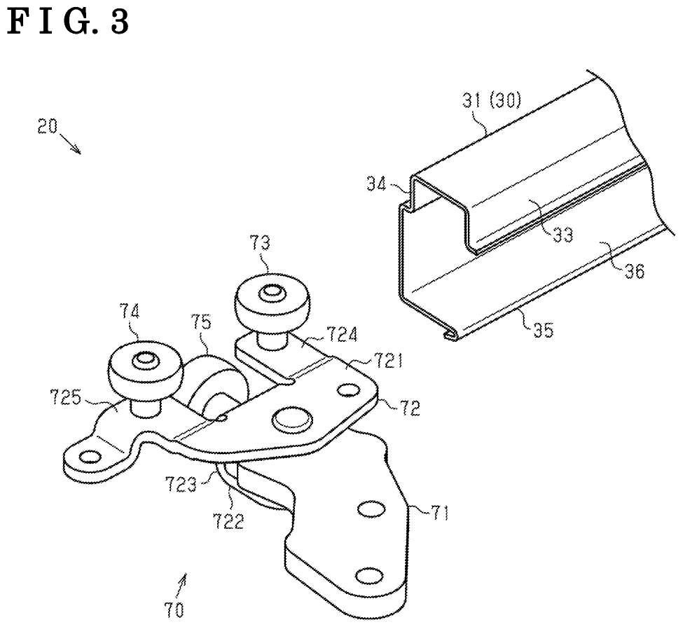

As illustrated in FIG. 3, the straight portion 31 and the curved portion 32 of the upper rail 30 each have a substantially C-shaped cross-section in a longitudinal direction. The straight portion 31 and the curved portion 32 of the upper rail 30 each include a pair of restriction walls 33 and 34 intersecting with the vehicle width direction, and a support wall 35 intersecting with the vehicle vertical direction. A pair of the restriction walls 33 and 34 are arranged at an interval in the vehicle width direction. An inner side surface of the support wall 35 in the upper rail 30 is a rolling surface 36 on which a weight of the slide door 13 acts. Further, it can be said that the support wall 35 constitutes a part of the upper rail 30, and in this regard, extends along the upper rail 30.

As illustrated in FIGS. 2 and 3, the upper guide unit 70 includes an upper fixed portion 71 fixed to the upper end portion of the slide door 13 via a fastening member such as a bolt, and an upper rotational arm 72 connected to the upper fixed portion 71 (slide door 13) so as to be rotatable relative to the upper fixed portion 71. The upper guide unit 70 includes a first upper guide roller 73, a second upper guide roller 74, and an upper load roller 75 that move along the upper rail 30.

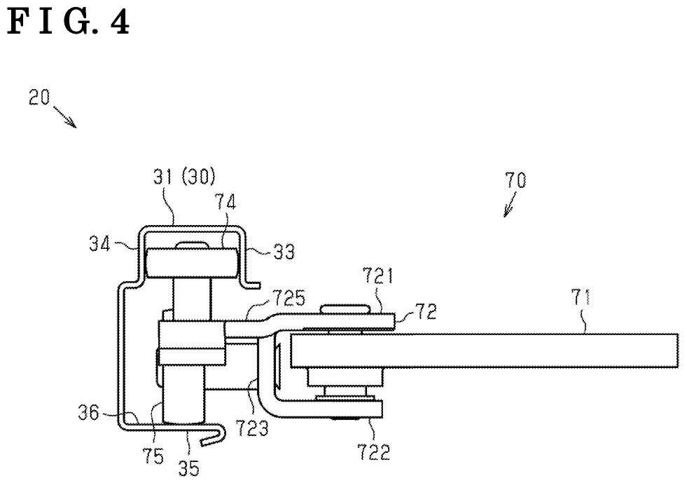

As illustrated in FIGS. 3 and 4, the upper rotational arm 72 includes an upper wall 721 and a lower wall 722 that intersect with the vehicle vertical direction, a side wall 723 making connection between the upper wall 721 and the lower wall 722 in the vehicle vertical direction, and a first protrusion wall 724 and a second protrusion wall 725 that extend inward in the vehicle width direction from the upper wall 721. The upper wall 721 and the lower wall 722 are connected to the upper fixed portion 71 so as to be rotatable relative to the upper fixed portion 71 around a rotational axis extending in the vehicle vertical direction. The first protrusion wall 724 supports the first upper guide roller 73 so as to be rotatable around a rotational axis extending in the vehicle vertical direction, and the second protrusion wall 725 supports the second upper guide roller 74 so as to be rotatable around a rotational axis extending in the vehicle vertical direction. Further, the side wall 723 supports the upper load roller 75 so as to be rotatable around a rotational axis perpendicular to the rotational axes of the first upper guide roller 73 and the second upper guide roller 74.

As illustrated in FIG. 4, the first upper guide roller 73, the second upper guide roller 74, and the upper load roller 75 of the upper rotational arm 72 are arranged inside the upper rail 30. Specifically, the first upper guide roller 73 and the second upper guide roller 74 are arranged between a pair of the restriction walls 33 and 34 of the upper rail 30, and the upper load roller 75 is arranged on the rolling surface 36 of the support wall 35 of the upper rail 30. When the slide door 13 is opened and closed, the first upper guide roller 73 and the second upper guide roller 74 each rotate in a state of contacting with one of the restriction walls of the upper rail 30, and thereby move along the upper rail 30. Further, when the slide door 13 is opened and closed, the upper load roller 75 rotates in a state of contacting with the support wall 35 (rolling surface 36) of the upper rail 30, and thereby moves along the upper rail 30. Thus, when the slide door 13 is opened and closed, the upper guide unit 70 moves along the upper rail 30 in a state of supporting the upper end portion of the slide door 13.

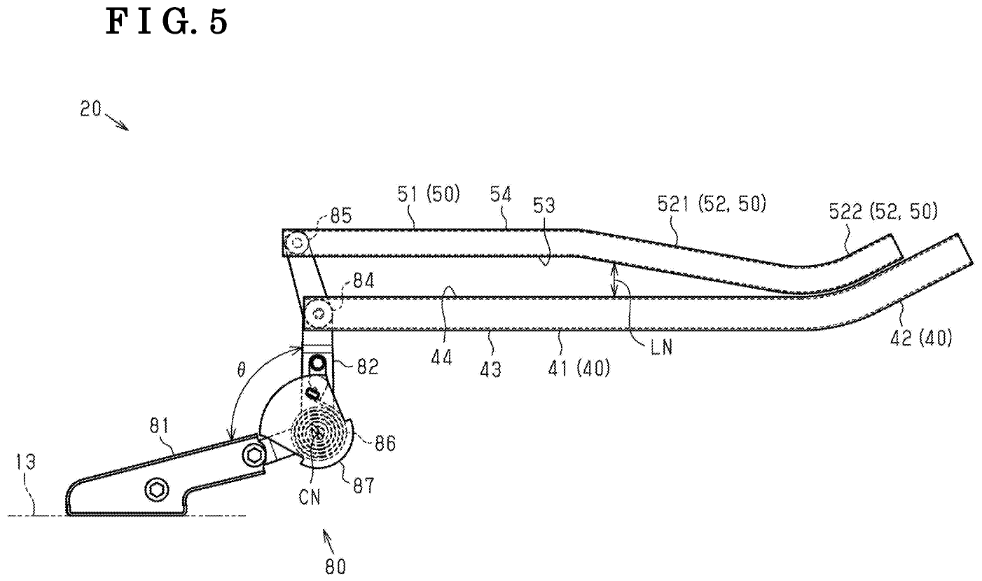

Next, the first lower rail 40, the second lower rail 50, and the lower guide unit 80 are described in detail with reference to FIGS. 5 to 7.

As illustrated in FIG. 5, the first lower rail 40 and the second lower rail 50 are arranged so as to be adjacent to each other in the vehicle width direction, and the second lower rail 50 is arranged more inside than the first lower rail 40 in the vehicle width direction. In other words, the second lower rail 50 is arranged to be closer to a passenger compartment than the first lower rail 40.

The first lower rail 40 includes a straight portion 41 extending to the vehicle front, and a curved portion 42 curved so as to extend inward in the vehicle width direction as a position shifts from a front end of the straight portion 41 to the vehicle front. The second lower rail 50 includes a straight portion 51 extending along the vehicle front-rear direction, and a curved portion 52 curved in such a way that a distance LN from the first lower rail 40 in the vehicle width direction gradually decreases as a position shifts from a front end of the straight portion 51 to the vehicle front. Specifically, the curved portion 52 of the second lower rail 50 includes a first curved portion 521 extending outward in the vehicle width direction as a position shifts to the vehicle front, and a second curved portion 522 extending inward in the vehicle width direction as a position shifts to the vehicle front.

A distance LN in the vehicle width direction between the straight portion 51 of the second lower rail 50 and the first lower rail 40 is maintained at a constant as a position shifts to the vehicle front. A distance LN in the vehicle width direction between the first curved portion 521 of the second lower rail 50 and the first lower rail 40 gradually becomes shorter as a position shifts to the vehicle front. A distance LN in the vehicle width direction between the second curved portion 522 of the second lower rail 50 and the first lower rail 40 is maintained at a constant as a position shifts to the vehicle front. Note that similarly to the upper rail 30, the straight portion 41 of the first lower rail 40 and the straight portion 51 of the second lower rail 50 each include not only a straight portion extending in parallel with the vehicle front-rear direction but also a straight portion extending in a direction slightly inclined from the vehicle front-rear direction.

As illustrated in FIG. 5, the straight portion 41 of the first lower rail 40 is longer than the curved portion 42 of the first lower rail 40, and the straight portion 51 of the second lower rail 50 is shorter than the curved portion 52 of the second lower rail 50. Further, the straight portion 41 of the first lower rail 40 is longer than the straight portion 51 of the second lower rail 50. Furthermore, in this embodiment, a length of the curved portion 42 in a longitudinal direction of the first lower rail 40 is shorter than a length of the curved portion 32 in a longitudinal direction of the upper rail 30. Thus, in the vehicle width direction, a full width of the first lower rail 40 and the second lower rail 50 is configured to be shorter than a full width of the upper rail 30. In this regard, the first lower rail 40 and the second lower rail 50 can be arranged at the lower end portion of the door opening 11 while amounts of inward protrusion thereof in the vehicle width direction are suppressed.

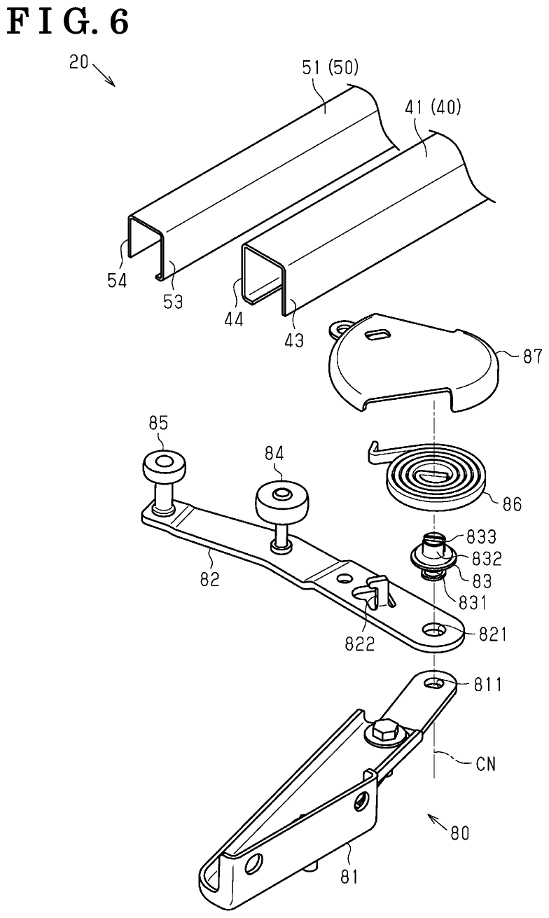

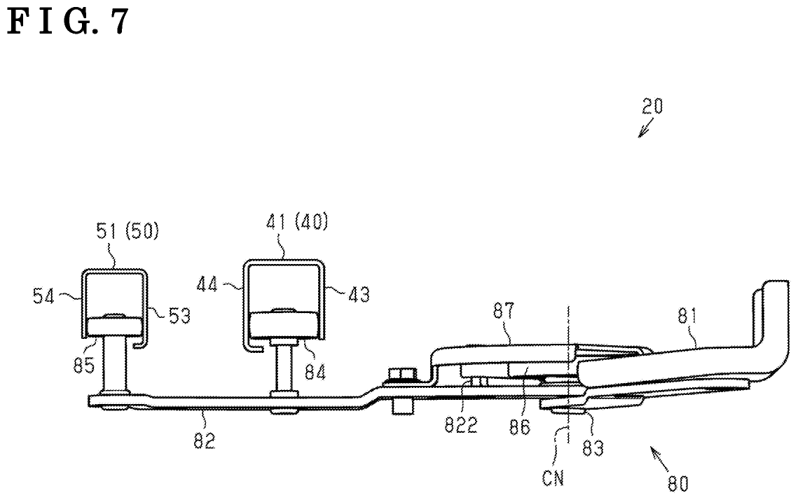

As illustrated in FIGS. 6 and 7, the first lower rail 40 and the second lower rail 50 each have a substantially C-shaped cross-section in the longitudinal direction. The straight portion 41 and the curved portion 42 of the first lower rail 40 each include a pair of restriction walls 43 and 44 intersecting with the vehicle width direction. A pair of the restriction walls 43 and 44 are arranged at an interval in the vehicle width direction. Similarly, the straight portion 51 and the curved portion 52 of the second lower rail 50 each include a pair of restriction walls 53 and 54 intersecting with the vehicle width direction. A pair of the restriction walls 53 and 54 are arranged at an interval in the vehicle width direction.

As illustrated in FIGS. 6 and 7, the lower guide unit 80 includes a lower fixed portion 81 fixed to the slide door 13, a lower rotational arm 82 connected to the lower fixed portion 81 (slide door 13) so as to be rotatable relative to the lower fixed portion 81, and a shaft portion 83 connecting the lower fixed portion 81 and the lower rotational arm 82 to each other. Further, the lower guide unit 80 includes a first lower guide roller 84 moving along the first lower rail 40, a second lower guide roller 85 moving along the second lower rail 50, a pressing member 86 pressing the lower fixed portion 81, and a cover 87 covering the pressing member 86. Note that the lower guide unit 80 does not include a lower load roller as a constituent corresponding to the upper load roller 75 that supports a weight of the slide door 13 in the upper guide unit 70.

The lower fixed portion 81 is a rod-shaped member constituted of a plurality of members. A proximal end portion of the lower fixed portion 81 is fixed to the lower end portion of the slide door 13 via a fastening member such as a bolt. At a distal end portion of the lower fixed portion 81, a non-circular engagement hole 811 is formed.

The lower rotational arm 82 is a rod-shaped member having a shape of a flat plate. At a proximal end portion of the lower rotational arm 82, a circular penetration hole 821 is formed. Further, in the lower rotational arm 82, at a position closer to a distal end than the proximal end portion, a lock piece 822 for locking a second end of the pressing member 86 is formed. The lock piece 822 is formed by cutting and raising a part of the lower rotational arm 82. The lower rotational arm 82 supports, at positions closer to the distal end than the lock piece 822, the first lower guide roller 84 and the second lower guide roller 85. The lower rotational arm 82 supports the first lower guide roller 84 and the second lower guide roller 85 so as to be rotatable around rotational axes extending in the vehicle vertical direction.

The shaft portion 83 includes an engagement shaft portion 831 engaging with the engagement hole 811 of the lower fixed portion 81, and a lock shaft portion 832 locking the pressing member 86. The engagement shaft portion 831 has a non-circular cross-sectional shape conforming to the engagement hole 811 of the lower fixed portion 81. In the lock shaft portion 832, a lock groove 833 receiving a first end of the pressing member 86 is formed in a radial direction. The shaft portion 83 cannot rotate relative to the lower fixed portion 81 by causing the engagement shaft portion 831 to engage with the engagement hole 811 of the lower fixed portion 81. Meanwhile, the shaft portion 83 can rotate relative to the lower rotational arm 82 around a rotational axis CN by being inserted through the penetration hole 821 of the lower rotational arm 82.

As illustrated in FIG. 7, the first lower guide roller 84 is arranged inside the first lower rail 40 so as to contact with the restriction wall 44 on an inner side in the vehicle width direction in the first lower rail 40. Further, the second lower guide roller 85 is arranged inside the second lower rail 50 so as to contact with the restriction wall 53 on an outer side in the vehicle width direction in the second lower rail 50. In other words, the lower guide unit 80 sandwiches the first lower rail 40 and the second lower rail 50 in the vehicle width direction by the first lower guide roller 84 and the second lower guide roller 85. Furthermore, as illustrated in FIG. 5, in a state where the first lower guide roller 84 engages with the straight portion 41 of the first lower rail 40, and the second lower guide roller 85 engages with the straight portion 51 of the second lower rail 50, the first lower guide roller 84 is positioned to be closer to the vehicle front than the second lower guide roller 85. For this reason, in the above-described state, the proximal end of the lower rotational arm 82 is directed in a direction slightly inclined from an outward vehicle width direction toward the vehicle front.

The pressing member 86 is what is called a spiral spring (power spring). The pressing member 86 is arranged at a connection location between the lower fixed portion 81 and the lower rotational arm 82. Specifically, the first end of the pressing member 86 is locked in the lock groove 833 of the shaft portion 83 integrated with the lower fixed portion 81, and the second end of the pressing member 86 is locked by the lock piece 822 of the lower rotational arm 82. As a result, the pressing member 86 presses the lower fixed portion 81 relative to the lower rotational arm 82. Assuming that an angle made by the lower fixed portion 81 and the lower rotational arm 82 is referred to as “an arm angle θ”, the pressing member 86 is attached so as to generate an initial load of increasing the arm angle θ in a state illustrated in FIG. 5. Accompanying change (decrease) in the arm angle θ, the pressing member 86 is elastically deformed, and thereby increases pressing force.

The cover 87 is fixed to the lower rotational arm 82 via a fastening member such as a bolt. The cover 87 is preferably shaped so as not to contact with the lower fixed portion 81 when the arm angle θ changes.

When the slide door 13 is opened and closed, the first lower guide roller 84 rotates in a state of contacting with the restriction wall 44 of the first lower rail 40, and thereby moves along the first lower rail 40. Similarly, the second lower guide roller 85 rotates in a state of contacting with the restriction wall 53 of the second lower rail 50, and thereby moves along the second lower rail 50. Thus, when the slide door 13 is opened and closed, in a state of supporting the lower end portion of the slide door 13, the lower guide unit 80 moves along the first lower rail 40 and the second lower rail 50.

Note that, in this embodiment, the central rail 60 has a configuration similar to that of the upper rail 30, and the central guide unit 90 has a configuration similar to that of the upper guide unit 70. For this reason, in the following, description of the central rail 60 and the central guide unit 90 is omitted.

The following describes operation of this embodiment.

First, an operation of the upper guide unit 70 when the slide door 13 is opened and closed is described with reference to FIG. 2.

When the slide door 13 is opened and closed, the upper guide unit 70 moves along the upper rail 30. At this time, the first upper guide roller 73 and the second upper guide roller 74 each rotate in a state of contacting with one of the restriction walls of the upper rail 30, and the upper load roller 75 rotates in a state of contacting with the support wall 35 (rolling surface 36) of the upper rail 30.

When the upper guide unit 70 moves along the straight portion 31 of the upper rail 30, i.e., when an opened degree of the slide door 13 is large, the upper rotational arm 72 moves along the upper rail 30 while maintaining a relative positional relation with the upper fixed portion 71. Meanwhile, when the upper guide unit 70 moves along the curved portion 32 of the upper rail 30, i.e., when the opened degree of the slide door 13 is small, the upper rotational arm 72 moves along the upper rail 30 while changing a relative positional relation with the upper fixed portion 71.

However, when moving along the upper rail 30, the upper rotational arm 72 does not change a posture thereof relative to the longitudinal direction of the upper rail 30 regardless of the opened degree of the slide door 13. Further, a movement trajectory TR of the upper load roller 75 is parallel with the upper rail 30 regardless of the opened degree of the slide door 13. For this reason, regardless of the opened degree of the slide door 13, at a contact point between the upper load roller 75 and the rolling surface 36 of the support wall 35, a rotational direction (circumferential direction) of the upper load roller 75 does not incline from a moving direction of the upper load roller 75. Thus, when the slide door 13 is opened and closed, the upper load roller 75 is unlikely to skid sideway relative to the support wall 35 of the upper rail 30.

Next, an operation of the lower guide unit 80 when the slide door 13 is opened and closed is described with reference to FIGS. 5, 8, and 9.

When the slide door 13 is opened and closed, the lower guide unit 80 moves along the first lower rail 40 and the second lower rail 50. At this time, the first lower guide roller 84 rotates in a state of contacting with the restriction wall 44 of the first lower rail 40, and the second lower guide roller 85 rotates in a state of contacting with the restriction wall 53 of the second lower rail 50.

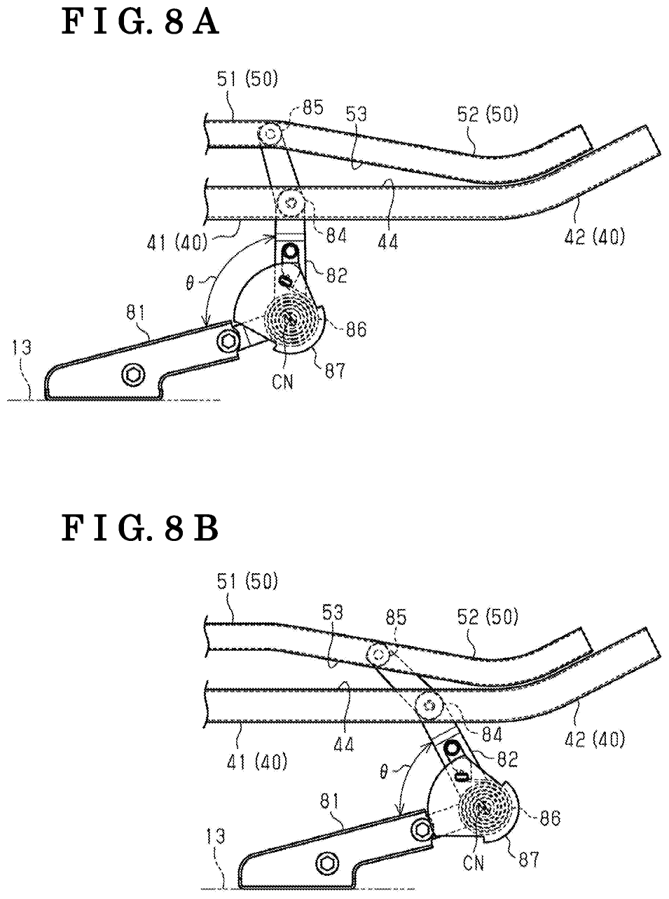

As illustrated in FIGS. 5 and 8A, when the lower guide unit 80 moves along the straight portion 41 of the first lower rail 40 and the straight portion 51 of the second lower rail 50, a relative positional relation between the lower rotational arm 82 and the lower fixed portion 81 is maintained. In other words, the lower guide unit 80 moves along the first lower rail 40 and the second lower rail 50 while maintaining an arm angle θ. Note that the arm angle θ in this case is the maximum angle of arm angles A that the lower guide unit 80 can take. Further, the pressing member 86 presses the lower fixed portion 81 even in the case illustrated in FIG. 5, and thus, it can be said that the pressing member 86 presses the lower fixed portion 81 even when the arm angle θ is the maximum.

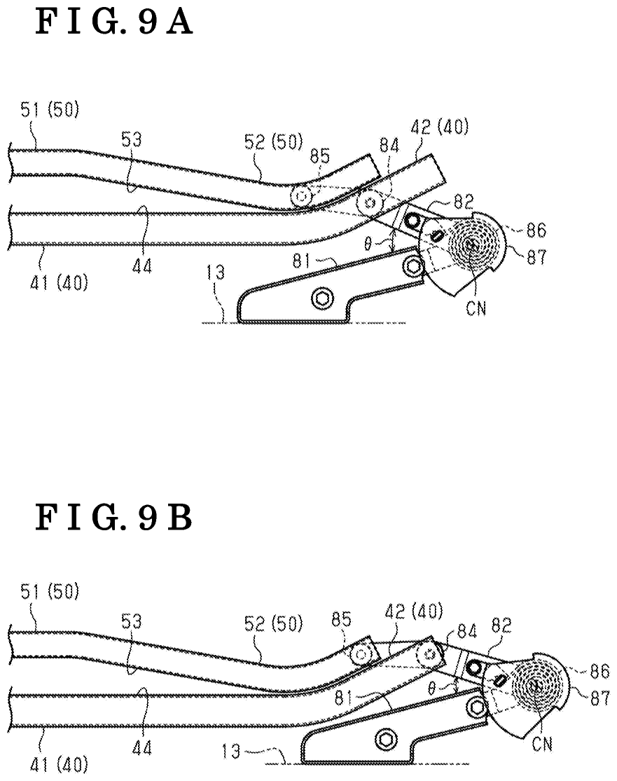

Meanwhile, as illustrated in FIGS. 8B, 9A, and 9B, when the lower guide unit 80 moves along the straight portion 41 and the curved portion 42 of the first lower rail 40 and the curved portion 52 of the second lower rail 50, a relative positional relation between the lower rotational arm 82 and the lower fixed portion 81 changes. In other words, the lower guide unit 80 moves along the first lower rail 40 and the second lower rail 50 while changing an arm angle θ.

Specifically, when the slide door 13 is closed toward the fully closed position, as illustrated in FIGS. 8B, 9A, and 9B in this order, the lower rotational arm 82 moves to the vehicle front while rotating in such a way that the proximal end portion of the lower rotational arm 82 is gradually directed toward the vehicle front. At this time, the lower fixed portion 81 connected to the proximal end portion of the lower rotational arm 82 moves inward in the vehicle width direction while moving to the vehicle front. However, in the course of closing of the slide door 13, the lower fixed portion 81 maintains a constant posture thereof, and for this reason, an arm angle decreases as the lower guide unit 80 advances to the vehicle front. Then, as illustrated in FIG. 9B, when the slide door 13 moves up to the fully closed position, the arm angle θ becomes the minimum angle, and the lower guide unit 80 is brought into a state of being folded to be small.

Meanwhile, as illustrated in FIGS. 9B, 9A, and 8B in this order, when the slide door 13 is opened from the fully closed position, the lower rotational arm 82 moves to a vehicle rear while rotating in such a way that the proximal end portion of the lower rotational arm 82 is gradually directed outward in the vehicle width direction. At this time, the lower fixed portion 81 connected to the proximal end portion of the lower rotational arm 82 moves outward in the vehicle width direction while moving to the vehicle rear. However, in the course of opening of the slide door 13, the lower fixed portion 81 maintains the constant posture thereof, and for this reason, an arm angle θ increases as the lower guide unit 80 advances to the vehicle rear. Then, when the lower guide unit 80 moves up to the position illustrated in FIG. 8A, the arm angle θ becomes the maximum angle, and the lower guide unit 80 is brought into the most unfolded state.

In the following description, an opened degree of the slide door 13 when the second lower guide roller 85 of the lower guide unit 80 is positioned at a boundary between the straight portion 51 and the curved portion 52 of the second lower rail 50 as illustrated in FIG. 8A is referred to as “an intermediate opened degree”.

Incidentally, the slide door 13 of this embodiment is supported at a side position of the vehicle body 12 by the upper guide unit 70, the center guide unit 90, and the lower guide unit 80. For this reason, moment acts on the slide door 13 in such a way that the upper end portion thereof at a position higher than a gravity center thereof tries to separate from the vehicle body 12, and the lower end portion thereof at a position lower than the gravity center thereof tries to approach the vehicle body 12. In other words, the slide door 13 applies, to the upper guide unit 70, force of pulling the upper guide unit 70 outward in the vehicle width direction, and applies, to the lower guide unit 80, force of pushing the lower guide unit 80 inward in the vehicle width direction.

Since the force with which the slide door 13 pushes the lower guide unit 80 is independent of an opened degree and a moving direction of the slide door 13, the slide door 13 pushes the lower guide unit 80 inward in the vehicle width direction even in the case illustrated in FIGS. 88, 9A, and 98. As a result, the second lower guide roller 85 tends to move to the vehicle front due to an inclination of the curved portion 52 of the second lower rail 50, and the first lower guide roller 84 tends to move to the vehicle front due to an inclination of the curved portion 42 of the first lower rail 40. In other words, the proximal end portion of the lower rotational arm 82 tends to rotate so as to be directed toward the vehicle front.

Thus, when an opened degree of the slide door 13 is smaller than the intermediate opened degree, moment is generated so as to rotate the lower rotational arm 82 in such a way that the proximal end portion thereof is directed toward the vehicle front. When the moment is generated with an opened degree of the slide door 13 being smaller than the intermediate opened degree, there is a possibility that an operating speed of the slide door 13 suddenly increases when the slide door 13 is closed near the fully closed position, or force necessary for operating the slide door 13 increases when the slide door 13 is opened from the fully closed position, for example.

In this regard, the lower guide unit 80 of this embodiment includes the pressing member 86 that presses the lower rotational arm 82 in the direction of increasing an arm angle θ and whose elastically deformed amount increases as the arm angle θ decreases. Thus, in the case where the slide door 13 is closed, when an opened degree of the slide door 13 becomes smaller than the intermediate opened degree, pressing force to the lower rotational arm 82 increases as the opened degree of the slide door 13 decreases. Accordingly, when the slide door 13 is closed toward the fully closed position, force in a direction (opening direction) opposite to the moving direction of the slide door 13 acts on the slide door 13, and thus, an operating speed of the slide door 13 is unlikely to suddenly increase.

Further, when the slide door 13 is positioned at the fully closed position, an arm angle is the minimum, and thus, pressing force of the pressing member 86 is the maximum. In other words, when the slide door 13 at the fully closed position starts to be opened, the arm angle θ tends to increase by pressing force of the pressing member 86, and the slide door 13 thereby tends to move toward the opening direction. For this reason, when the slide door 13 is opened from the fully closed position, force in the same direction (opening direction) as the moving direction of the slide door 13 acts thereon, and thereby, force necessary for opening the slide door 13 is unlikely to become large.

The following describes advantageous effects of this embodiment.

(1) When moving along the upper rail 30, the upper rotational arm 72 of the upper guide unit 70 does not rotate regardless of the opened degree of the slide door 13 so as to change a posture thereof relative to the longitudinal direction of the upper rail 30. Thus, at a contact point between the upper load roller 75 and the rolling surface 36, a rotational direction (circumferential direction) of the upper load roller 75 does not incline from a moving direction of the upper load roller 75, and for this reason, the upper load roller 75 is unlikely to skid sideway relative to the rolling surface 36. Therefore, the slide door support device 20 can suppress sideway skidding of the upper load roller 75 that supports a weight of the slide door 13.

(2) In the slide door support device 20, the upper rail 30 includes the support wall 35 provided with the rolling surface 36. For this reason, the slide door support device 20 eliminates necessity of forming, in the vehicle body 12, the rolling surface 36 for the upper load roller 75.

(3) Since the lower rotational arm 82 does not need to be provided with a lower load roller, a cross-section of the lower rotational arm 82 does not need to have a shape whose flexural rigidity and torsional rigidity are high. In other words, in the slide door support device 20, a shape of the lower rotational arm 82 can be simple.

(4) The slide door support device 20 includes the pressing member 86 that presses the lower fixed portion 81 so as to increase an arm angle θ of the lower guide unit 80. The pressing member 86 presses the slide door 13 via the lower fixed portion 81 in a moving direction when the slide door 13 is opened. As a result, when an opened degree of the slide door 13 is small, the slide door support device 20 can reduce force acting in a closing direction of the slide door 13 due to a form of engagement of the first lower rail 40 and the second lower rail 50 with the lower guide unit 80.

Specifically, when the slide door 13 is closed, the slide door support device 20 can suppress a sudden increase in an operating speed of the slide door 13 when an opened degree of the slide door 13 is smaller than the intermediate opened degree. Thus, the slide door support device 20 can prevent injury-suffering feeling from being given to a user who operates the slide door 13 to be closed. Further, when the slide door 13 is opened from the fully closed position, the slide door support device 20 can suppress an increase in operation force necessary for opening the slide door 13. In other words, the slide door support device 20 can suppress degradation of operability for a user who operates the slide door 13 to be opened.

(5) When the slide door 13 is positioned at the fully closed position, in the slide door support device 20, an arm angle θ becomes the minimum, and for this reason, pressing force becomes the maximum. Thus, when the slide door 13 starts to be opened from the fully closed position, the pressing member 86 applies relatively large force to the slide door 13 in the opening direction. Therefore, the slide door support device 20 can cause the pressing force of the pressing member 86 to function as assist force for opening the slide door 13, and make the assist force relatively large.

(6) An arm angle θ becomes the maximum when an opened degree of the slide door 13 is large, in other words, when the first lower guide roller 84 moves along the straight portion 41 of the first lower rail 40, and the second lower guide roller 85 moves along the straight portion 51 of the second lower rail 50. In this regard, according to this embodiment, even when an opened degree of the slide door 13 is large, the pressing member 86 presses the lower fixed portion 81, and for this reason, a posture of the lower guide unit 80 becomes stable. Specifically, a posture of the first lower guide roller 84 and the second lower guide roller 85 inside the first lower rail 40 and the second lower rail 50 becomes stable. Thus, when an opened degree of the slide door 13 is large, the slide door support device 20 can make a posture of the lower end portion of the slide door 13 stable.

(7) Since the pressing member 86 is a spiral spring, the pressing member 86 can easily apply pressing force to the lower fixed portion 81.

(8) When the lower guide unit 80 does not include the pressing member 86, movement of the lower rotational arm 82 relative to the lower fixed portion 81 is not restricted before the lower guide unit 80 is assembled to the first lower rail 40 and the second lower rail 50. For this reason, in this case, it becomes difficult to insert, into the first lower rail 40 and the second lower rail 50, the first lower guide roller 84 and the second lower guide roller 85 supported by the distal end of the lower rotational arm 82.

As compared with this, the lower guide unit 80 of this embodiment includes the pressing member 86. Accordingly, action of pressing force of the pressing member 86 restricts movement of the lower rotational arm 82 relative to the lower fixed portion 81. Thus, it is possible to avoid a situation of difficulty of inserting, into the first lower rail 40 and the second lower rail 50, the first lower guide roller 84 and the second lower guide roller 85 supported by the distal end of the lower rotational arm 82 when the lower guide unit 80 is assembled to the first lower rail 40 and the second lower rail 50.

(9) When the slide door 13 is positioned at the fully closed position, the pressing member 86 of the lower guide unit 80 presses the slide door 13 via the lower fixed portion 81. A posture of the slide door 13 at the fully closed position, in other words, a posture of the slide door 13 during vehicle running is made stable. Accordingly, the slide door support device 20 can suppress generation of abnormal noise due to slight movement of the slide door 13 during vehicle running.

This embodiment can be implemented with the following modifications. This embodiment and the following modifications may be implemented in combination with each other within a range where technical discrepancy does not occur.

The pressing member 86 may be a different spring such as a leaf spring, or may be elastically deformable rubber or resin. For example, when the pressing member 86 is a leaf spring attached to the lower fixed portion 81, the leaf spring may elastically deform by being compressed between the lower rotational arm 82 or the vehicle body 12 and the lower fixed portion 81 when the slide door 13 is positioned at the fully closed position.

When an arm angle θ is smaller than a predetermined opened angle smaller than the maximum opened angle, the pressing member 86 may press the lower fixed portion 81. In other words, when an opened degree of the slide door 13 is equal to or larger than the intermediate opened degree, the pressing member 86 may not press the lower fixed portion 81.

The upper rail 30 may not include the support wall 35 on which the upper load roller 75 rolls. In this case, a surface on which the upper load roller 75 rolls is preferably formed on the vehicle body 12.

The slide door 13 may be configured as what is called a power slide door that is opened and closed by drive of an actuator. In this case, the slide door support device 20 can suppress complication of control of the actuator when an opened degree of the slide door 13 is small.

The central guide unit 90 may include or may not include a constituent corresponding to the upper load roller 75.

A slide door support device according to this disclosure supports, at a vehicle body, a slide door that opens and closes a door opening formed on a side surface of the vehicle body. The slide door support device includes first and second lower rails and a lower guide unit. The first lower rail is arranged at a lower end portion of the door opening. The second lower rail is arranged at the lower end portion of the door opening and on an inner side of the first lower rail in a vehicle width direction. The lower guide unit is connected to a lower end portion of the slide door. The first lower rail includes a straight portion extending to a vehicle front, and a curved portion curved so as to extend inward in the vehicle width direction as a position shifts from a front end of the straight portion to the vehicle front. The second lower rail includes a straight portion extending to the vehicle front, and a curved portion curved in such a way that a distance from the first lower rail gradually decreases as a position shifts from a front end of the straight portion to the vehicle front. The lower guide unit includes a first lower guide roller moving along the first lower rail, a second lower guide roller moving along the second lower rail, a lower fixed portion fixed to the slide door, a lower rotational arm including a proximal end portion connected so as to be rotatable relative to the lower fixed portion and supporting the first lower guide roller and the second lower guide roller at positions closer to a distal end than the proximal end portion, and a pressing member pressing the lower fixed portion. An angle made by the lower fixed portion and the lower rotational arm is assumed to be an arm angle. When the first lower guide roller moves along the straight portion and the curved portion of the first lower rail, and the second lower guide roller moves along the curved portion of the second lower rail, the arm angle gradually decreases as an opened degree of the slide door decreases. The pressing member presses the lower fixed portion in a direction of increasing the arm angle.

According to the above-described configuration, the arm angle decreases when the slide door is closed, and increases when the slide door is opened. In other words, when the arm angle increases, the slide door is opened. In this regard, the slide door support device with the above-described configuration includes the pressing member that presses the lower fixed portion in a direction of increasing the arm angle. For this reason, the pressing member can press, via the lower fixed portion, the slide door in the opening direction. Thus, when an opened degree of the slide door is small, the slide door support device can reduce force acting on the slide door in a closing direction due to a form of engagement of the first lower rail and the second lower rail with the lower guide unit.

In the above-described slide door support device, as the arm angle decreases, the pressing member may increase pressing force to the lower fixed portion.

In the slide door support device with the above-described configuration, when the slide door is positioned at a fully closed position, the arm angle becomes minimum, and thus, the pressing force becomes maximum. For this reason, when the slide door starts to be opened from the fully closed position, the pressing member can press, with large force, the slide door toward the opening direction. Thus, the slide door support device can reduce force necessary for opening the slide door from the fully closed position.

In the above-described slide door support device, the arm angle may become maximum when the first lower guide roller moves along the straight portion of the first lower rail, and the second lower guide roller moves along the straight portion of the second lower rail. The pressing member may press the lower fixed portion even when the arm angle is maximum.

According to the above-described configuration, even when an opened degree of the slide door is large, the pressing member presses the lower fixed portion, and thus, a posture of the lower fixed portion when the slide door is opened and closed becomes stable. For this reason, when an opened degree of the slide door is large, the slide door support device can make a posture of the lower end portion of the slide door stable.

In the above-described slide door support device, the pressing member may be a spiral spring.

The slide door support device with the above-described configuration can easily apply pressing force to the lower fixed portion.

The above-described slide door support device may include an upper rail arranged at an upper end portion of the door opening, and an upper guide unit connected to an upper end portion of the slide door. The upper rail may include a straight portion extending to the vehicle front, and a curved portion curved so as to extend inward in the vehicle width direction as a position shifts from a front end of the straight portion to the vehicle front. The upper guide unit may include a first upper guide roller and a second upper guide roller that move along the upper rail, an upper load roller rolling on a rolling surface that extends along the upper rail, and an upper rotational arm including a proximal end portion connected so as to be rotatable relative to the slide door and supporting the first upper guide roller, the second upper guide roller, and the upper load roller at positions closer to a distal end than the proximal end portion.

According to the above-described configuration, when the slide door is opened and closed, in the lower guide unit, the first lower guide roller moves along the first lower rail, and the second lower guide roller moves along the second lower rail. For this reason, there is a case where, depending on an opened degree of the slide door, the lower rotational arm rotates so as to change a posture thereof relative to a longitudinal direction of the first lower rail or the second lower rail when moving along the first lower rail or the second lower rail.

Meanwhile, when the slide door is opened and closed, in the upper guide unit, the first upper guide roller and the second upper guide roller move along the one upper rail. For this reason, when moving along the upper rail, the upper rotational arm does not rotate in a manner of changing a posture thereof relative to a longitudinal direction of the upper rail. As a result, regardless of the opened degree of the slide door, at a contact point between the upper load roller and the rolling surface, a rotational direction (circumferential direction) of the upper load roller is unlikely to incline from a moving direction of the upper load roller. Thus, the slide door support device can suppress sideway skidding of the upper load roller that supports a weight of the slide door.

In the slide door support device, the upper rail may include the rolling surface.

The slide door support device with the above-described configuration eliminates necessity of forming, in the vehicle body, the rolling surface for the upper load roller.

In the above-described slide door support device, the lower rotational arm may have a shape of a flat plate.

When the upper load roller is provided in the upper rotational arm, the lower rotational arm may not have a cross-sectional shape whose bending rigidity and flexural rigidity are high. In this respect, in the slide door support device with the above-described configuration, a shape of the lower rotational arm can be made simple.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A slide door support device supporting, at a vehicle body, a slide door that opens and closes a door opening formed on a side surface of the vehicle body, comprising:
a first lower rail arranged at a lower end portion of the door opening;
a second lower rail arranged at a lower end portion of the door opening and on an inner side of the first lower rail in a vehicle width direction; and
a lower guide unit connected to a lower end portion of the slide door, wherein
the first lower rail includes a straight portion extending to a vehicle front, and a curved portion curved so as to extend inward in a vehicle width direction as a position shifts from a front end of the straight portion to a vehicle front,
the second lower rail includes a straight portion extending to a vehicle front, and a curved portion curved in such a way that a distance from the first lower rail gradually decreases as a position shifts from a front end of the straight portion to a vehicle front,
the lower guide unit includes: a first lower guide roller moving along the first lower rail; a second lower guide roller moving along the second lower rail; a lower fixed portion fixed to the slide door; a lower rotational arm including a proximal end portion connected so as to be rotatable relative to the lower fixed portion and supporting the first lower guide roller and the second lower guide roller at positions closer to a distal end than the proximal end portion; and a pressing member pressing the lower fixed portion,
an angle made by the lower fixed portion and the lower rotational arm is assumed to be an arm angle,
when the first lower guide roller moves along a straight portion and a curved portion of the first lower rail, and the second lower guide roller moves along a curved portion of the second lower rail, the arm angle gradually decreases as an opened degree of the slide door decreases, and the pressing member presses the lower fixed portion in a direction of increasing the arm angle.

2. The slide door support device according to claim 1, wherein,
as the arm angle decreases, the pressing member increases pressing force to the lower fixed portion.

3. The slide door support device according to claim 1, wherein
the arm angle becomes maximum when the first lower guide roller moves along a straight portion of the first lower rail, and the second lower guide roller moves along a straight portion of the second lower rail, and
the pressing member presses the lower fixed portion even when the arm angle is maximum.

4. The slide door support device according to claim 1, wherein
the pressing member is a spiral spring.

5. The slide door support device according to claim 1, further comprising:
an upper rail arranged at an upper end portion of the door opening; and
an upper guide unit connected to an upper end portion of the slide door, wherein
the upper rail includes a straight portion extending to a vehicle front, and a curved portion curved so as to extend inward in a vehicle width direction as a position shifts from a front end of the straight portion to a vehicle front, and
the upper guide unit includes: a first upper guide roller and a second upper guide roller that move along the upper rail; an upper load roller rolling on a rolling surface that extends along the upper rail; and an upper rotational arm including a proximal end portion connected so as to be rotatable relative to the slide door and supporting the first upper guide roller, the second upper guide roller, and the upper load roller at positions closer to a distal end than the proximal end portion.

6. The slide door support device according to claim 2, further comprising:
an upper rail arranged at an upper end portion of the door opening; and
an upper guide unit connected to an upper end portion of the slide door, wherein
the upper rail includes a straight portion extending to a vehicle front, and a curved portion curved so as to extend inward in a vehicle width direction as a position shifts from a front end of the straight portion to a vehicle front, and
the upper guide unit includes: a first upper guide roller and a second upper guide roller that move along the upper rail; an upper load roller rolling on a rolling surface that extends along the upper rail; and an upper rotational arm including a proximal end portion connected so as to be rotatable relative to the slide door and supporting the first upper guide roller, the second upper guide roller, and the upper load roller at positions closer to a distal end than the proximal end portion.

7. The slide door support device according to claim 5, wherein
the upper rail includes the rolling surface.

8. The slide door support device according to claim 5, wherein
the lower rotational arm has a shape of a flat plate.

9. The slide door support device according to claim 6, wherein
the lower rotational arm has a shape of a flat plate.
